(19) United States
(12) Patent Application Publication
(10) Pub. No.: US 2007/0237459 A1
(43) Pub. Date: Oct. 11, 2007

(54) Connector device for coupling optical fibres, and method of production thereof

(76) Inventors: Jan Watte, Grimbergen (BE); Daniel Daems, S' - Gravenwezel (BE); Bart Volckaerts, Borgerhout (BE); Heidi Ottevaere, Halle (BE); Hugo Thienpont, Halle (BE)

Correspondence Address: BAKER & DANIELS LLP, 300 NORTH MERIDIAN STREET, SUITE 2700, INDIANAPOLIS, IN, 46204, US

(21) Appl. No.: 11/707,377

(22) Filed: Feb. 16, 2007

Related U.S. Application Data
(62) Division of application No. 10/555,341, filed on Oct. 28, 2005.

(51) Int. Cl. G02B 6/26

(52) U.S. Cl. 385/39

(57) ABSTRACT

A connector device for coupling non-aligned optical fibres (19, 20), in which light is directed from one fibre to another by a reflector (12) and lenses (13, 14) and the positional relationship between the ends of the optical fibres and the reflector is determined by means (31, 32, 33) for locating the end of each optical fibre to be coupled in a predetermined position both parallel to and transverse the length of the fibre. Also covers a connector device for optically coupling an optical fibre (101, FIG. 14) to deliver light to or receive light from another optical component (102) by way of a lens (110), in which the positional relationship between the end of the optical fibre and the said other optical component is determined by means (106) for locating the end of the said optical fibre in a predetermined position both parallel to and transverse the length of the fibre with respect to the said optical component.

### CROSS-REFERENCE TO RELATED APPLICATION

This application is a divisional of U.S. patent application Ser. No. 10/555,341, filed Oct. 28, 2005 which is incorporated herein by reference.

### BACKGROUND AND SUMMARY

The present invention relates generally to a connector device for coupling optical fibres, and to a method of production of such a connector device.

The problems of connecting optical fibres to allow transmission of light from one to the other are well known. Conventionally the optical fibres to be connected or “spliced” are cleaved to provide an accurately determined angle, usually perpendicular but possibly inclined at an angle greater than 6°. The cleaved face is an optically flat surface which is placed in direct contact with a corresponding end surface of the optical fibre to be spliced or, if spaced, an index matching material may be introduced into the air gap between the facing surfaces in order to reduce losses. In communications systems where development and change may take place it is necessary to be able to accommodate the possibility of changing the connections between different optical fibres so that a splice must be releasable or replaceable. In order to allow for re-positioning of optical fibres within cabinets it has been necessary, because of the end-to-end or “in-line” splicing configurations used until now, to leave a certain spare length of optical fibre available to accommodate the shortening of the optical fibre when a redundant splice is cut out to be replaced by another. This excess length of surplus optical fibre represents a bottleneck for downsizing, for example tap off and subscriber equipment in fibre optic access network deployments. The large number of spare lengths of fibre result in storage and management problems, increasing the size of connector cabinets and the complexity of the tasks involved in making and changing connections.

However, in order to produce a connector capable of coupling non-aligned optical fibres cognisance must be taken of the divergence of the exit beam from the exit end of an optical fibre. In order to avoid losses on coupling it is necessary to capture all of this light at the inlet end of an optical fibre being connected to the above-mentioned exit end. It is for this reason that the face-to-face butt splicing of in-line connections, by bringing two fibre ends into physical contact, has been conventionally chosen as that least likely to result in losses even though it has inherent problems and difficulties of its own. It would be far preferable if the connections between optical fibres could be made with a simple plug-in arrangement in which the fibres did not need to be positioned accurately in line with one another. This corresponds, for example, to the plug-board arrangement used for electrical conductors in which conductors to be connected can be simply inserted (having a suitable terminal or plug) into side-by-side sockets in order to effect connection.

The present invention seeks to provide a connector device for coupling optical fibres in which it is not necessary for the fibres to be in-line with one another, allowing them to be side-by-side in what may be called a “parallel” configuration, or at an angle to one another (probably the most useful angle being 90°) in what may be called an “inclined” configuration. For the sake of generality, any coupling other than the serial or in-line butt coupling of a conventional splice will be referred to hereinafter as a non-aligned coupling. This term will be understood to refer to both parallel (that is side-by-side) and inclined couplings as defined above. It is also possible to include so-called splitters and combiners within the meaning of the term “connector”. It will also be appreciated that a connector may couple a single pair of optical fibres or a plurality of pairs of fibres.

According to one aspect of the present invention, therefore, there is provided a connector device for coupling non-aligned optical fibres, in which light is directed from one fibre to another by a reflector and the positional relationship between the ends of the optical fibres and the reflector is determined by means for locating the end of each optical fibre to be coupled in a predetermined position both parallel to and transverse the length of the fibre.

The need for accurate positioning of the ends of the fibres transverse their length will be apparent in that it is necessary to ensure optical coupling of reflected light without losses. The requirement for accurate positioning longitudinally of the length of the optical fibres arises from the above-discussed form of the exiting light which is coupled into the optical fibre not as a beam of parallel light, but rather as a diverging or converging beam (depending on whether it is exiting or arriving respectively). For this purpose collimating lenses are required between the ends of the optical fibres and the reflector if a plane reflector is used. Of course, it is not essential for the reflector to be a plane reflector. If a curved reflector, such as a concave (possibly parabolic) reflector is utilised it is possible for it to receive non-parallel light beams and to reflect the incident light to a region laterally offset from the source region. Naturally, the ends of the optical fibres and the collimating lenses must be located in predetermined positions with respect to the reflector in order to direct the parallel beams to one another via the reflector. The ends of the optical fibres must also be located in such a position as to ensure that the apparent point source of light from the end of the optical fibre is located in the focal plane of the lens in order for this to form the light into a parallel collimated beam directed at the reflector in the case of the output or exit fibre, and for receiving light from the reflector in the case of the receiving fibre.

In one embodiment the said collimating lenses are integrally formed with the said means for locating the ends of the optical fibres to be coupled, there being provided means for determining the relative position of the reflector and the said means for locating the ends of the optical fibres to be coupled, the latter being adapted to locate the optical fibre at a predetermined distance in relation to the focal length of the lenses. Alternatively the collimating lenses may be heterogeneously aligned with mechanical positioning tools or cavities with the said means for locating the ends of the optical fibres to be coupled. Also alternatively, however, the lenses may be independent of the means for locating the ends of the optical fibres to be coupled and, even, may be formed integrally with the reflector if this is formed as an optical body with a reflector surface on a rear face. Techniques for producing integrally-formed lens and reflector bodies or integrally formed lens and fibre-locating bodies will be described in more detail hereinbelow.

The means for locating the ends of the optical fibres to be coupled may comprise a locating member having openings for receiving the ends of the optical fibres to be coupled and means for determining the relative position and orientation of the said locating member with respect to the reflector. Such relative position—and orientation—determining means may simply comprise spacers or, as in the preferred embodiment, may comprise co-operating form-engagement members on or carried by the said reflector and the said locating member. Likewise it is preferred that the said locating member has means for securing it in a predetermined fixed spaced relationship with respect to the reflector.

In embodiments in which the reflector is formed as an optical body this is preferably a generally prismatic element having at least one reflector surface at which reflection takes place by total internal reflection. For a general case of non-aligned fibres a single reflector surface may be provided. For the specific case of parallel, side-by-side, non-aligned fibres, a reflector prism having two reflector surfaces orthogonal to one another is preferred. This configuration, giving a 180° diversion of incident light, enables simple plug-in connection of adjacent optical fibres.

Alternatively, instead of using a reflecting prism, a reflector (or reflectors) formed by suitable coated surfaces, for example at 45° to the direction of incident and reflected light may be employed. Now, because the fibres are not in-line with one another, it is not necessary to provide for substantial lengths of spare fibre for repositioning of couplings, first because a simple plug-in connection is envisaged, in which case it is not necessary to cut and re-cleave the fibre in order to make a fresh connection, and secondly because any shortening of the fibre can be accommodated by a corresponding shortening of its partner in the connection so there is never any risk that a connection cannot be made because the two fibres intended to be connected cannot be made to reach one another. As mentioned above, the most useful non-aligned inclinations of optical fibres to be coupled are likely to be 180° and 90°. These two angles allow certain advantages to be obtained and may find particular application in patch panels of optical distribution frames.

Although surfaces at which total internal reflection are used this may still result in some small transmission losses and to combat this the reflector surface may be metalised, for example with an aluminium or other metal layer, to improve its specific reflectance. Likewise, the reflector surface may be formed with or associated with a diffraction grating allowing for multiplexing and de-multiplexing wavelengths. Depending on the grating characteristics, the coupling fibre can be dual fibre ribbon or a multiple fibre ribbon. In such cases the coupling element may also be used as a splitter or combiner or a wavelength selective multiplexer or demultiplexer.

Means by which the optical components can be secured together in a supporting structure will be described in more detail with reference to the specific embodiments. Techniques by which the optical components may be made include diamond turning and reactive ion etching processes in which a high molecular weight polymer preferably, but not exclusively, with linear chains, is irradiated in selected regions with highly energetic particles, followed by a treatment which acts selectively on the irradiated material leaving the non-irradiated material unchanged.

According to a second aspect of the present invention, therefore, a method of producing a component of a connector device for non-aligned optical fibres comprises the steps of: irradiating a selected region of a polymer body having a high molecular weight with a particle beam having sufficient local energy transfer to be capable of breaking the molecular chains of the polymer; subjecting the irradiated regions of the polymer material to a subsequent treatment to cause a change in the physical or mechanical properties of the irradiated regions whereby to enable a component having a desired shape and/or surface properties to be formed; and reproducing the component thus formed using mass production techniques such as micro replication, injection moulding or hot embossing. This latter step is preferably performed using high quality polymeric materials like cyclo olefin co-polymer (COCs) or optical ceramics.

The method of the invention may be performed by irradiating the polymer with a particle beam of substantially circular cross section for a period of time, determined in relation to the energy and the dose rate of the particle beams, such as to produce a substantially cylindrical region of determined length of irradiated material, and selectively removing the modified, irradiated material by solvent etching to produce cavities of a defined size and shape to receive the ends of optical fibres and locate them with respect to the component both parallel to and transverse the length of the optical fibre. This production technique allows high accuracy in that the control of the irradiating beam can be achieved with positioning accuracies in the micrometer and sub-micrometer range. The boundary between radiated and non-irradiated material is extremely sharp so that the subsequent treatment leaves an extremely well-defined smooth surface with sharp edges. Such cavities can provide sockets for reception of the ends of optical fibres, and the depth of such cavities can be accurately determined so as to provide a shoulder for locating the end of the optical fibre accurately parallel to the length thereof.

Other surface features, such as lenses, may be made by a technique in which the component is irradiated with a beam, especially a particle beam of substantially circular cross section for a time period determined in relation to the energy and dose rate of the particle beams, and the subsequent treatment of the irradiated region may comprise exposing the surface thereof to a monomer vapour (possibly the same material as the polymer) at an elevated temperature at which the monomer diffuses into the irradiated regions whereby to cause local intumescence. By ensuring good circularity of the irradiating beam the local intumescence may cause an effectively spherical surface to be formed in an accurately located position on the body. Such surface thus forms a micro lens which may, for example, be formed on a common body with the cavities for receiving the ends of the optical fibres, or may be formed on a common body with the reflector. Alternatively, a lens plate may be formed with one or a plurality of such lenses, and the structure of the connector may involve means for locating this plate in relation to the reflector body and a fibre-locating plate having cavities as discussed above. By using a homogeneous beam of circular cross section it is possible to generate a lens with a spherical surface. Aspheric lenses may be produced by using an inhomegeneous beam, and by varying the cross-sectional shape and the homogeneity suitably it is further possible to produce cylindrical lenses for special purposes. There is an optimum relationship between the irradiation (both duration and energy density) and the subsequent treatment both in terms of the duration of contact with the diffusing monomer and its temperature in the reactor in order to avoid defects in the lens shape upon intumescences such as poor swelling, deformation, excessive volumetric expansion, depressed lens surface etc.

The reflector surface may be formed by a similar technique involving an irradiation step performed with a continuous stream of particles such as protons with relative translation of the beam and the polymer body being undertaken to form an irradiated region of selected shape. The subsequent treatment (preferably chemical treatment) may then result in removal of the irradiated material, for example by etching or other technique, to leave a smooth optically flat surface suitable for acting as a reflector.

As mentioned above the energetic particles may be protons as these can be generated in a cyclotron with the necessary energy, typically in the region of 8 MeV. Other heavier ions, including alpha particles and carbon and lithium ions with different energies, may be used if the energy level is sufficiently high to break the polymer chains and create the required deep structure.

The starting polymer is preferably one having linear molecular chains although polymers with branched or cross-linked chains may be usable as well. In particular, the relatively heavier alpha particles may lend themselves to the irradiation of relatively thicker elements of polymer. Conversely, if an electron beam is used it is probable that the total energy is likely to permit use only with relatively thinner elements of polymer. It is expected that electrons will lose an appreciable amount of energy when interacting with the polymer.

A third aspect of the present invention provides a connector device for coupling non-contacting optical fibres, comprising at least one lens and means for locating the ends of the optical fibres to be coupled in a predetermined positional relationship with respect to the said lens, whereby to direct light leaving one of the optical fibres substantially entirely into the other optical fibre. Various different embodiments may be devised, for example, in one embodiment this means the said means for locating the ends of the optical fibres in a predetermined positional relationship with respect to the lens comprise at least one alignment plate having openings for receiving the ends of the fibres and locating them in a predetermined position with respect to the said lens.

The lens may be separate from or integrally formed with the or a said alignment plate. There may be two such alignment plates, in which case each may have one or more lens integrally formed therewith. As in embodiments discussed hereinabove the openings in the alignment plate or plates may be blind or through holes and in each case may be tapered to allow easy introduction of the optical fibre whilst nevertheless securing a close tolerance location of the end. A transparent stop plate may be provided in embodiments in which the alignment plate has through holes. The end face of an optical fibre is contacted by the stop plate upon insertion of a fibre to form part of a coupling.

The present invention may be considered more generally to comprehend a connector device for coupling optical fibres, in which light is directed from one fibre to another by an optical component other than the fibres themselves, in which the positional relationship between the ends of the optical fibres and the said optical component is determined by means for locating the end of each optical fibre to be coupled in a predetermined position both parallel to and transverse the length of the fibre. In this case the optical component may be a reflector, for non-aligned couplings, or a lens, for aligned couplings. In such a connector device the said means for determining the positional relationship between the ends of the optical fibres and the said optical component or system may comprise at least one alignment plate having openings in predetermined positions for receiving the ends of optical fibres. The said optical component or system may comprise or include at least one lens formed integrally with the said alignment plate of with another part of the system.

The present invention also comprehends a connection device for coupling optical fibres, in which light exiting one fibre is directed to another by optical transmission means outside the fibres in the form of one or more lenses located in a fixed position with respect to fibre and locating means of the connector. In such a device the fibre end locating means may comprise openings in an alignment plate for receiving the ends of the fibres, the lens or lenses also being formed integrally on the alignment plate.

### BRIEF DESCRIPTION OF THE DRAWINGS

Various embodiments of the present invention will now be more particularly described, by way of example, with reference to the accompanying drawings, in which:

FIG. 1a is a diagram illustrating the major components in a connector formed according to the principles of the present invention;

FIG. 1b illustrates a corresponding arrangement having a front face reflector;

FIG. 2a is a schematic section through an exemplary embodiment;

FIG. 2b is a section through a corresponding embodiment with a front face reflector;

FIG. 3 is a perspective view of an embodiment of the invention formed for connecting multiple optical fibres;

FIG. 4 is a diagram illustrating the major steps in the method for forming microcavities in a polymer body suitable for use in the connector of the invention;

FIG. 5a is a diagram illustrating the major steps in forming a micro lens array suitable for use in an embodiment of the invention;

FIG. 5b is a graph showing the temperature program of a monomer diffusion treatment;

FIG. 6a is a schematic diagram illustrating a further embodiment of the invention for connecting non-aligned optical fibres;

FIG. 6b is a corresponding embodiment having a front face reflector;

FIG. 7a is a schematic view of an embodiment utilising a non-planar reflector which does not require lenses;

FIG. 7b is a corresponding embodiment with a front surface parabolic reflector;

FIG. 8 is a schematic view of a prism having locating pegs for engagement with a base plate;

FIG. 9 is a schematic view of a base plate suitable for use with the prism of FIG. 8;

FIG. 10 shows the two components of FIGS. 8 and 9 in the relative positions they would occupy just before coupling;

FIG. 11 shows a schematic layout of a device incorporating such components;

FIG. 12 is an illustration of an embodiment using a fibre clamping arrangement to retain the fibres in position; and

FIG. 13 is a schematic view of a further embodiment for coupling in-line fibres.

### DETAILED DESCRIPTION OF THE DRAWINGS

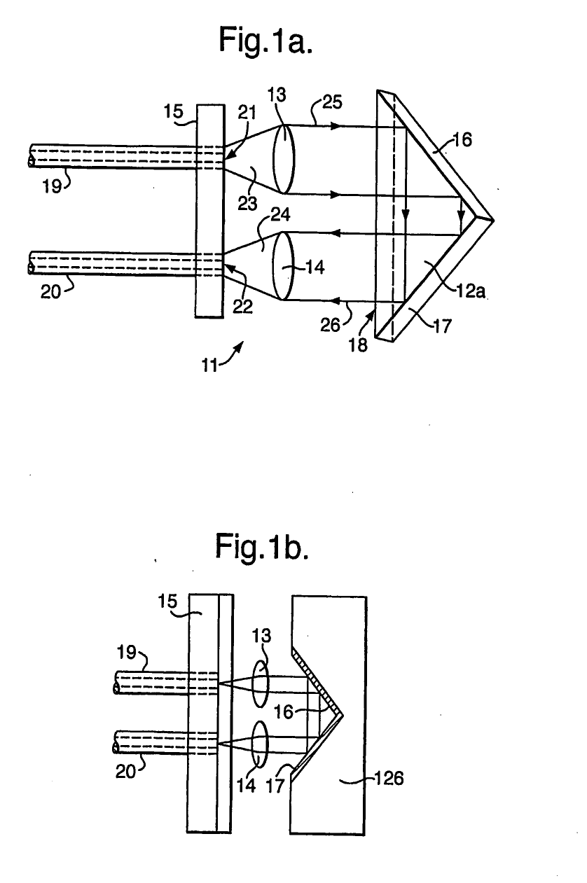

Referring first to FIG. 1a an optical connector for non-aligned optical fibres comprises an assembly generally indicated 11 the main components of which are a reflector prism 12a, two lenses 13, 14 and a fibre locating plate 15. The prism 12a is a triangular prism having two reflector faces 16, 17 at right angles to one another and a planar input/output face 18. As is known, by suitable choice of material for the body of the prism 12a, such as polymethyl methacrylate (PMMA) the critical angle for reflection is less than 45° so that light incident on the input/output face 18 orthogonal thereto strikes one of the two inclined reflector faces 16, 17 at 45°, is reflected thereby parallel to the light transmission face 18 to the other of the two reflector faces 16, 17 at which it is reflected back out through the light transmission face 18 parallel to but offset from the direction of incident light. The critical surfaces of this embodiment may be provided with anti-reflection coating to avoid Fresnel reflection losses along the light-path within the connector.

In FIG. 1a, two optical fibres are generally indicated 19, 20. Each has a respective cleaved end face 21, 22 strictly perpendicular to the length of the optical fibre. As will be appreciated, light coupled into or out from an optical fibre such as the fibres 19, 20 through end faces 21, 22 forms a generally conical beam illustrated in FIG. 1 with the reference numerals 23, 24. The lenses 13, 14 then act to collimate these beams to provide parallel beams 25, 26 which are incident on the reflecting surfaces 16, 17. Thus, as can be seen from FIG. 1a, if the longitudinal positioning of the optical fibres 19, 20 is adjusted appropriately in relation to the lenses 13, 14 all of the light leaving one fibre is incident on the associated lens and can be coupled into the other fibre via the two reflections at the reflector 16, 17 with substantially no losses. Any lateral offset of an optical fibre 19, 20 in relation to a lens 13, 14 will result in incomplete light transmission and corresponding losses. Likewise, if the ends 21, 22 of the optical fibres are too close to the lenses 13, 14 then not all of the light leaving an optical fibre will be incident on a lens and, again, losses will be incurred.

FIG. 1b shows a corresponding configuration using a mirror 12b with a front surface reflector in place of the prism 12a. The same reference numerals have been used to identify the same or corresponding components. Obviously a second surface mirror (rear face coated) could also be used.

For a practical optical fibre connecting device it is not possible to provide means for adjusting the positions of the lenses and/or the ends of the optical fibres in order to ensure no losses, although for most known manufacturing techniques dimensional tolerances would not normally be sufficiently fine to ensure that no losses occurred. In accordance with the present invention, however, it is possible to build a structure which has inherent accuracy in positioning of the component parts such as to allow plug-in coupling of optical fibres with minimum transmission losses.

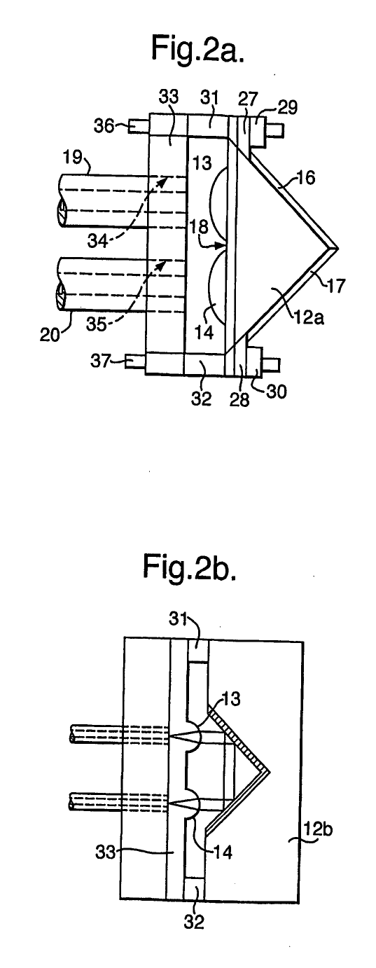

FIG. 2a illustrates an embodiment of the invention utilising the basic components of a structure such as that described in relation to FIG. 1. Those components which fulfill the same or corresponding functions have been identified with the same reference numerals. Thus, the prism 12a has reflector surfaces 16, 17 and a light transmission surface 18. In this embodiment, however, the lenses 13, 14 are integrally formed on the light transmission surface 18 by a process which will be described in more detail below. The prism 12a has two transverse lugs 27, 28 by which the prism is located between fixed locating members 29,30 and spacers 31, 32 which define the separation between the prism and a base plate 33 which has cavities 34, 35 for receiving optical fibres 19, 20. The spacers 31, 32, in this embodiment, have openings passing therethrough for receiving clamping pins 36, 37.

Correspondingly FIG. 2b shows an embodiment using a front silvered mirror 12b and an alignment plate 33 in which the lenses 13, 14 are integrally formed.

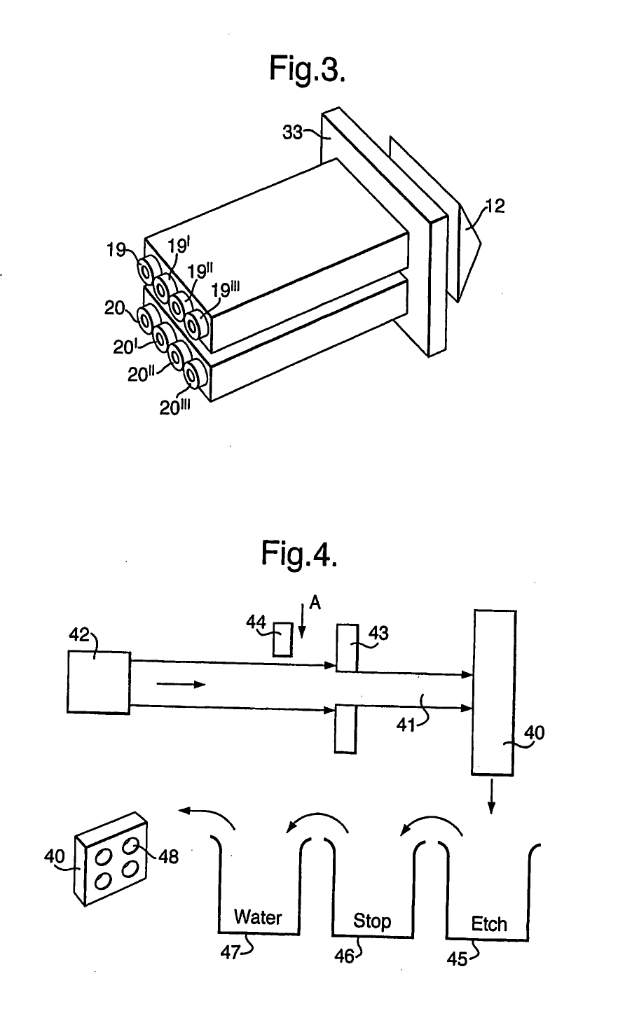

FIG. 3 illustrates an alternative embodiment, similar to that of FIG. 2, in which the base plate 33 is adapted to receive connectors bearing a plurality of optical fibres 19, 19′, 19″, 19′″, and 20, 20′ 20″, 20′″, the prism 12 in this case being elongate in relation to the length of the prism 12 in the embodiment of FIG. 2.

As previously mentioned, the cavities 34, 35 accurately define the positions of the ends of the optical fibres 19, 20 in relation to the lenses 13, 14 and the reflectors 16, 17. Precise positioning is important in order to obtain optical coupling. FIG. 4 accordingly illustrates the steps in a process by which accurately positioned cavities can be formed in a body to produce the cavity plate 33. A body 40 of suitable material such as polymethyl methacrylate (PMMA) or other positive resist material such as a high molecular weight polymer, preferably, but not exclusively, one with linear chains, is targeted by a proton beam 41 generated by a cyclotron 42. Schematically shown is a stop 43 which defines the size and cross sectional shape of the proton beam 41 targeting the body 40, and a shutter 44 which can be moved in the direction of the arrow A to intercept the proton beam from the cyclotron 42 and thereby define a precise exposure time for the body 40.

Irradiation of the polymethyl methacrylate body 40 with protons activates sites in the PMMA body resulting from the energy exchange from the impacting protons with the molecular chains of the PMMA body through which they travel. Consequently the polymer chains break and activated sites are created. These activated sites can be exploited in a number of ways in order to shape the body of PMMA to form highly efficient coupling components. As illustrated in FIG. 4 the proton beam is circular in cross section and of very small diameter (in the region of 125 μm) corresponding with the cladding diameters of the fibres and can be targeted on the body 40 with high precision.

After irradiation the body 40 is selectively solvent etched to remove the radiation-activated regions. Etching is performed in an etchent bath 45 and the body 40 is thereafter transferred into a subsequent etchant “stop” bath 46 at which the etching is terminated, and then into a water bath 47 for rinsing. The finished product comprises a body 40 having a plurality of cavities 48. Because of the high accuracy which can be achieved in the irradiation step the cavities 48 are accurately positioned in an array. Typically the pitch between adjacent cavities may be 250 μm. It is possible to produce parallel sided, smooth, sharp-edged cavities using this technique. Alternatively by taking advantage of the scattering of the protons, the profiles of the cavities 48 may be conical. In this way tapering holes may be formed that allow for introduction of optical fibres into a wider end quickly and easily, whilst nevertheless achieving close tolerance positioning of the fibre end at the narrow end of the cavity at the other side of the plate, at which the end faces of the optical fibres are located. By limiting the irradiation time, blind cavities 48 can be formed or, if desired, cavities passing right through the body 40 in the manner of through holes can be formed, the resulting cavitied body being suitable for use as the aforementioned base plate or cavity plate 33.

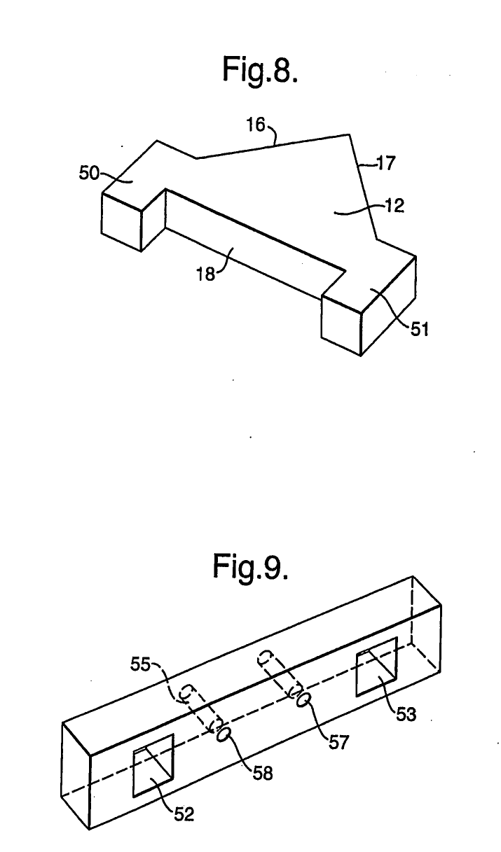

In an alternative procedure (not illustrated) the body 40 may be moved continuously during irradiation in order to define the shape of a body. The prism 12 may be formed in this way having optically flat side surfaces and projections for mechanical alignment as will be described in relation to FIG. 8.

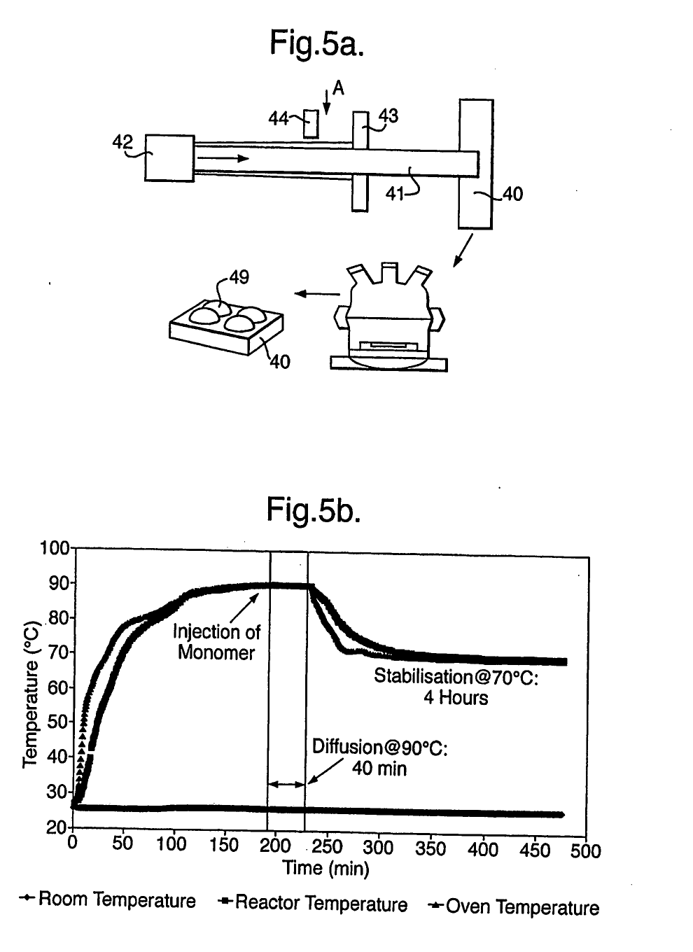

FIG. 5a illustrates an alternative procedure in which, after irradiation of a successive set of regions of a polymer body with a circular proton beam to provide radiation-activated sites in a two dimensional array over the surface of the body at accurately defined positions the body is treated with a monomer vapour which is diffused into the irradiated regions of the PMMA body. This diffusion of the monomer effectively “grows” enlarged areas by causing intumescence of the irradiated regions which results in part-spherical lens surfaces 49 projecting from the flat face of the body 40. The diffusion takes place in a reaction vessel, generally indicated in FIG. 5a. The reaction vessel is heated, for example in an oven (not shown) to bring it to a stabilised temperature. As can be seen in FIG. 5a the reaction vessel has three ports or interfaces respectively for temperature control, injection of the MMA monomer and control of the pressure. In use of the reaction vessel, the polymer body irradiated as described above is mounted on a holder (not shown) within the vessel which is positioned strictly perpendicular to the gravitational force and held rigorously in a fixed position. This is important since any movement of the body, or misalignment with respect to the gravitational force during the treatment process may result in a displacement or misalignment of the optical axis of the lenses being formed.

FIG. 5b illustrates one example of the type of conditions under which intumescence takes place and lens formation can be accomplished by diffusion of the MMA monomer in the irradiated zones where the bonds are broken. In this example it will be seen that it takes about two hours for the interior of the vessel to reach a temperature of 90° C. At this point the MMA monomer is introduced into the monitor vessel and intumescence takes place for about forty minutes at a temperature of 90° C. Thereafter full polymerisation is accomplished by reducing the temperature to 70° C. and sustaining the temperature for about four hours.

It is, of course, possible that the cavities 48 and the spherical lens surfaces 49 may be formed on opposite faces of the same body. Such an arrangement is illustrated for example in FIG. 9. The relationship between irradiation time, choice of diffusing monomer, duration of exposure and diffusion temperature, can be used to determine the precise degree of intumescence and thus the precise shape of the surface. Consequently the focal length of the lens thus formed may be predetermined.

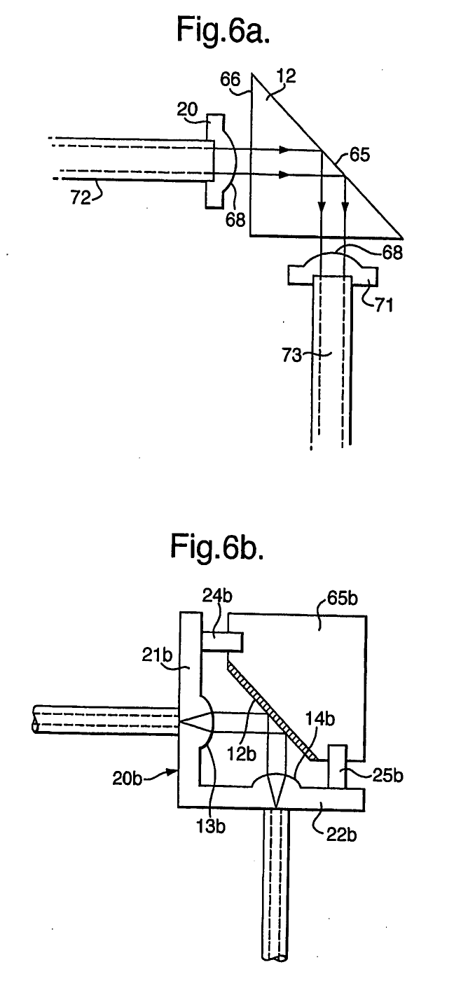

FIG. 6a illustrates an alternative embodiment in which the prism 12 has a single reflecting surface 65 and two light transmission surfaces 66, 67. Lenses 68, 69 on respective alignment plates 70, 71 couple light from optical fibres 72, 73 into the prism 12. The optical fibres 72, 73 are at right angles to one another. A connector of this configuration can be useful in patch panels where arriving and departing fibres are not lying in the same plane. Obviously the same principle can be applied to optical fibres lying at an angle other than 90° to one another by providing suitably shaped prisms or bridging pieces.

FIG. 6b shows a similar embodiment using a front face mirror 65b with a reflecting coating 12b and an angle section alignment plate 20b having two limbs 21b, 22b with integrally formed lenses 13b, 14b. Spacers 24b, 25b locate the mirror surface 12b accurately with respect to the two limbs 21b, 22b of the alignment plate 20b in two dimensions.

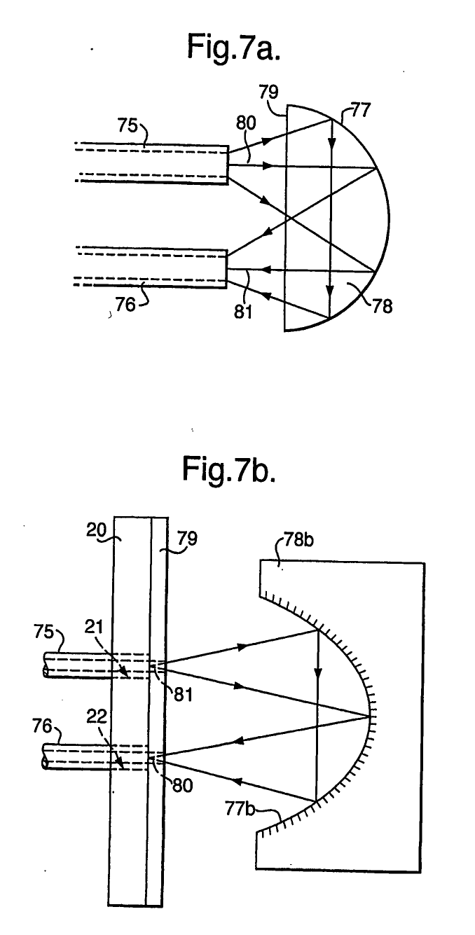

FIG. 7a illustrates an embodiment in which collimating lenses are not required. Here, two parallel non-aligned optical fibres 75, 76 are allowed to couple directly with a parabolic reflector surface 77 of a PMMA body 78 having a planar light transmission surface 79. The light emitted, for example, from optical fibres 75 is directed at the reflector surface 77 in a divergent beam 80. The reflector 77 reflects this light as a convergent beam 81 directed at the end face of the optical fibre 76 such that the entrance pupil is in line with the plane end face 82 and substantially all of the light from the fibre 75 is thereby coupled into the fibre 76. A suitable spacer (not shown) is provided between the fibres 75, 76 and the light transmission face 79 of the optical body 78 to ensure the appropriate focusing. Because a parabolic reflector will only reflect a parallel beam from light incident through its focal point, and since each of the optical fibres 75, 76 provides divergent light beams which do not pass through the focal point, appropriate optical coupling can be achieved by suitable positioning of the fibres.

FIG. 7b illustrates a similar configuration using a mirror 78b having a coated front face 77b. This embodiment has an apentured alignment plate 20 with through holes 21, 22 for optical fibres 75, 76 and a stop plate 79 with micro apertures 80, 81 the diameter of which corresponds to that of the fibre cores.

FIG. 8 is a perspective view of a prism formed by the selective etching process described above. As can be seen the light transmission face 18 is bounded at each end by two prismatic locating projections or pegs 50, 51 which upon assembly engage in correspondingly shaped openings 52, 53 in the alignment base plate illustrated in FIG. 9. This base plate differs from the corresponding plate 33 of the embodiment of FIG. 2 in that it has blind cavities 55, 56 for receiving the ends of optical fibres and lenses 57, 58 grown by the intumescent process described in relation to FIG. 5 in alignment therewith and at a spacing determined by the relationship between the thickness of the alignment base plate 54 and the depth of the blind cavities 55, 56. For short distances of the order of 100 μm cylindrical lenses may also be used. These are formed by translating the irradiated body in the beam according to a specific profile and subsequently etching away in a chemical treatment.

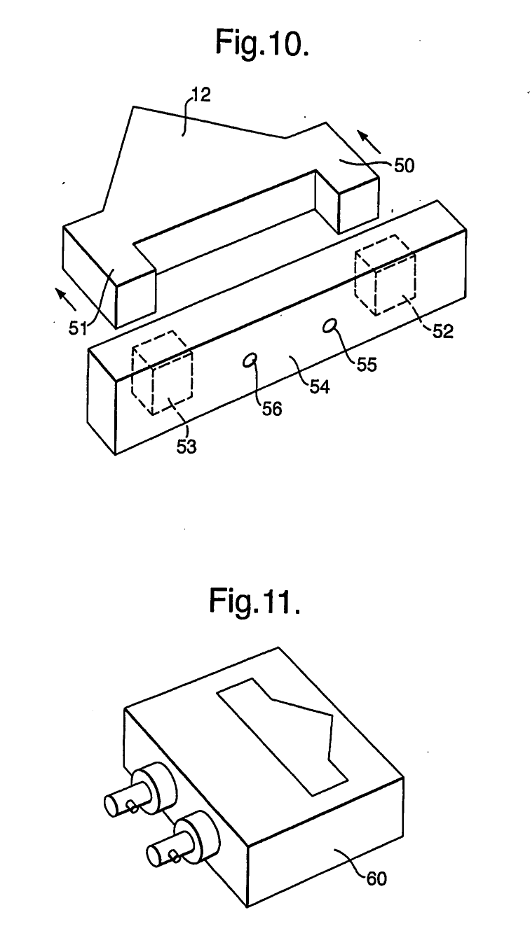

FIG. 10 illustrates the prism 12 and base plate 54 in a relative position immediately before the alignment projections 50, 51 are introduced into the corresponding apertures 52, 53. The blind cavities 55, 56 are tapered to allow easy introduction of an optical fibre at the open end whilst providing precise definition of its transverse position at the narrow end.

As can be seen in FIG. 11, an assembly comprising the base plate 54 and prism 12 may be held in position within a correspondingly shaped cavity in a connector block 60. Crimp and key assembly elements 61 such as are described in the Applicant's copending British patent application 0216434.1 can be used to insert optical fibres into the entrance holes of the structure. Elements which are not spring loaded may be provided to compensate for the longitudinal forces on the optical fibres due to cleave length tolerances. In this case a buckling channel for the fibre may be provided in order to prevent bending losses as a result of fibre insertion. A cover (not shown) can be a snap fit or welded to the assembled structure to complete the device. Index-matching gel may be applied to the holes of the alignment structure that snap fits to the prism.

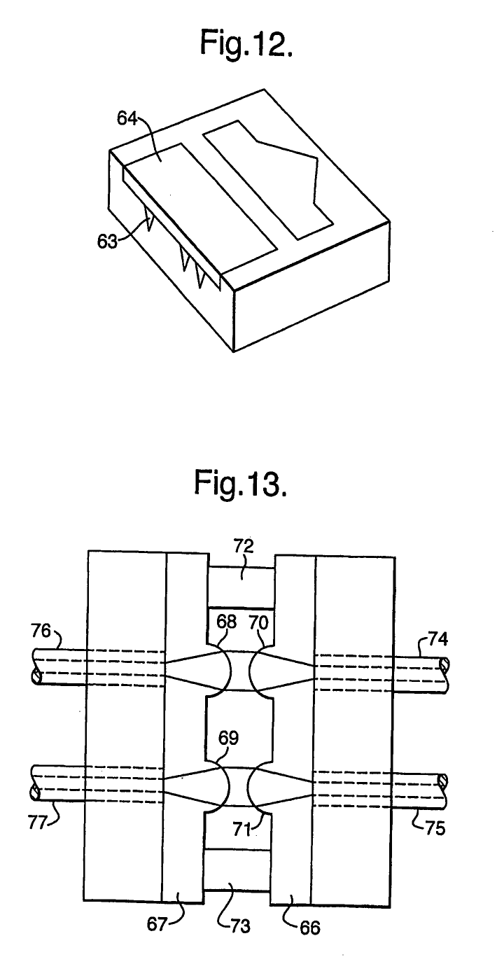

Alternatively, as shown in FIG. 12, the fibres may be held in positions in V-grooves 63 by a hingeable lid 64 which can be held shut by a spring clamp (not shown).

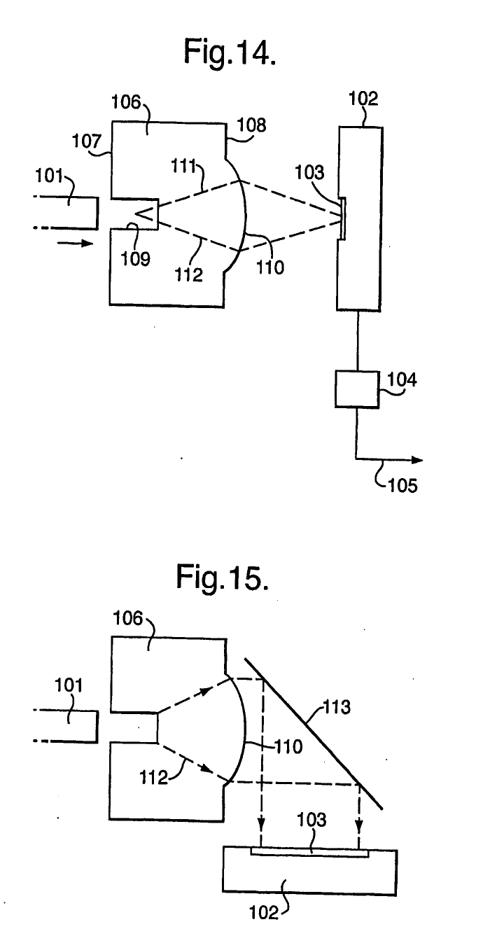

Finally, FIG. 13 schematically illustrates an in-line connector arrangement using two parallel alignment plates 66, 67 with integrally formed lenses 68, 69 and 70, 71 held spaced apart by spacers 72, 73. These alignment plates have blind holes to locate the fibres in pairs 74, 75 and 76, 77. They could of course alternatively have accurately formed through holes (tapered or not) with a cooperating stop plate of transparent material, which itself may have even smaller micro holes to line up in register with the light paths from the fibres. This embodiment has no reflector.

A further aspect of the present invention relates generally to a development of the connector device hereinbefore described for coupling non-aligned optical fibres. It has become apparent that the same coupling principles can be applied to a coupling not just between two fibres, but also between one fibre and another optical component such as a light source or photo detector.

Accordingly, this further aspect of the present invention provides a connector device for optically coupling an optical fibre to another optical component whereby to deliver light to or receive light from it, in which the positional relationship between the end of the optical fibre and the said other optical component is determined by means for locating the end of the said optical fibre in a predetermined position both parallel to and transverse the length of the fibre with respect to the said optical component.

In a preferred embodiment there is provided a lens in the path of light between the end of the said optical fibre and the said other component. The need for a lens will, in general, be dependent on the form of the said other optical component, and in particular whether the light-sensitive surface thereof or the light generated thereby can be directed to enter the optical fibre in a conversing beam without the need for a lens. In the majority of cases a lens is expected to be preferable in order to obtain the most effective degree of conversance. In embodiments having such a lens, the lens is preferably one formed by irradiation of selected regions of a body of polymer material followed by a treatment including selective exposure to a monomer at or above a critical temperature at which the monomer diffuses into the radiated regions of the polymer.

The means for locating the ends of the fibres may be formed by irradiation of a selected region of a body of polymer material, followed by a treatment including selective exposure to a monomer at or above a particular temperature at which the monomer diffuses into the radiated regions of polymer, and thereafter a selective etching of the thus-treated region to result in an accurately-formed opening for receiving the end of the fibre whereby to locate it in the said predetermined position.

The present invention also comprehends a method of producing a connector device according to this further aspect by the steps of irradiating at least one selected region of a body of polymer material; treating the irradiated region by selective exposure to a monomer at or above a critical temperature at which the monomer diffuses into the irradiated region of the polymer; selective etching of the thus-treated region of the polymer to result in an accurately-formed opening for receiving the end of the optical fibre to be connected; and optionally treating another part of the body of polymer to form a lens surface.

In the preferred method, the lens surface is formed by intumescence resulting from contact with the irradiated region of the polymer by a monomer vapour. Once the master connector device has been formed. Production of the component may be achieved using mass production techniques such as micro-replication, ejection moulding or hot embossing.

Various embodiments of this further aspect of the present invention will now be more particularly described, by way of example, with reference to the accompanying drawings, in which:

FIG. 14 is a sectional view through a first embodiment of the invention; and

FIG. 15 is a sectional view through an alternative embodiment of the invention.

Referring now to FIGS. 14 and 15 of the drawings, there is shown an optical fibre generally indicated 101 which is intended to be optically coupled to a photo detector generally indicated 102 having a photosensitive surface 103. The photo detector is connected to an amplifier 104 the output of which is supplied via a line 105 to electrical components for managing, or manipulating the electrical signal as appropriate.

The optical connector device of the invention comprises a monolithic body 106 of polymeric material having a front face 107 and a rear face 108. These faces may be substantially parallel to one another or may diverge at an angle in dependence on the nature of the optical coupling it is intended to perform. In the front face 107 is formed a recess or cavity 109 which is accurately formed to the dimensions of the optical fibre 101 such that this can be optically coupled to the connector 106 simply by introduction into the cavity 109. Suitable means (not shown) may be provided for retaining the optical fibre in position in the cavity. On the rear face 108 of the body 106 is a substantially spherical curved surface 110 the curved surface 110 is shaped and dimensioned in relation to the cavity 109 such that a beam of light (the outer rays of which are illustrated by the two broken lines 111, 112) which represents the exit or entering cone of light from an optical fibre 101 located in the cavity 109, is refracted at the interface 110 to a focal area on the sensitive surface 103 of the photodetector. A similar configuration, not illustrated in detail, may be employed for a source of light where, again, the relationship between the end of the optical fibre and the source of light needs to be established accurately.

In the embodiment of FIG. 14, although not shown in detail, there is naturally present a physical interconnection between the body 106 and the photodetector 102 which enables a precise relationship to be established between the position and orientation of the cavity 109, and therefore the end of the optical fibre 101 and the photo-sensitive surface 103 by means of an adjustable connection or a fixed, predetermined connection as suits the case. It will be seen that such a connector provides for “in-line” connection of the optical fibre 101 to a photo sensor. There may be circumstances where the photo-sensitive surface of a photodetector cannot conveniently be located in line with the direction of the optical fibre, in which case the embodiment of FIG. 15 may be employed. In this embodiment the same or corresponding components have again been allocated the same reference numerals. Here, however, the photo sensitive surface 103 lies parallel to the length of the optical fibre 101 rather than orthogonal to it as in the embodiment in FIG. 14, and light is reflected by a reflector 113 positioned between the reflective surface 110 and the photo detector 102. In this embodiment, unlike that of FIG. 14, the light from the refractor surface 110 is collimated, that is forms a parallel beam directed at the reflector 113, rather than being focused at a particular area of the photo sensitive surface 103 as in the embodiment of FIG. 14.

1. A method of producing a component of a connector device for aligned or non-aligned optical fibers, comprising the steps of:
irradiating a selected region of a polymer body having a high molecular weight with a particle beam having sufficient energy to be capable of breaking the molecular chains of the polymer,
subjecting the irradiated regions of the polymer material to a subsequent treatment to cause a change in the physical or mechanical properties of the irradiated region to form a component having a desired shape, and/or surface features, and
reproducing the component using mass production techniques such as micro replication or injection moulding.

2. A method as claimed in claim 1, in which the component is irradiated with a particle beam of substantially circular cross section for a time determined in relation to the energy absorbed dose in the region of the particles to produce a substantially cylindrical region of determined length, and selectively removing the modified material by solvent etching to produce cavities of a defined size and shape to receive the ends of optical fibers and locate them in determined positions with respect to the component both parallel to and transverse the length of the optical fiber.

3. A method as claimed in claim 1, in which the component is irradiated with a particle beam of substantially circular cross section for a time period determined in relation to the energy of the particles, and the subsequent treatment of the irradiated region comprises exposing the surface thereof to a monomer vapor at an elevated temperature at which the monomer diffuses into the irradiated regions to cause local intumescence.

4. A method as claimed in claim 1, in which the irradiation step is performed with a continuous stream of particles and relative translation of the beam and the polymer body takes place to form an irradiated region of selected shape, and the subsequent treatment results in ablation of the irradiated material to leave a body having a desired shape.

5. A method as claimed in claim 4, in which the ablation of irradiated material is effected by chemical etching to result in at least one substantially flat smooth surface suitable to act as a reflector.

6. A method as claimed in claim 3, in which the elevated temperature at which diffusion takes place is in the region of 70° C.

7. A method as claimed in any of claim 1, in which the beam of energetic particles is composed of protons or other heavy ions, such as alpha particles, or carbon or lithium ions.

8. A method as claimed in any of claims 1, in which the component body is electroplated before being used as a master for reproduction by micro replication techniques.

9. A method as claimed in any of claim 1, in which the polymer material is one having linear molecular chains.

10. A method of producing a connector device for optically coupling an optical fiber to another optical component other than an optical fiber, in which light exiting the fiber is directed to the other optical component by optical transmission means outside the fiber and the other optical component in the form of one or more lenses located in a fixed position with respect to fiber end locating means of the connector, and the fiber end locating means comprising openings in an alignment plate for receiving the ends of the fibers, the lens or lenses also being formed integrally on the alignment plate, and the positional relationship between the end of the optical fiber and said other optical component being determined by means for locating the end of the said optical fiber in a predetermined position both parallel to and transverse the length of the fiber with respect to said other optical component, the method including the steps of:
irradiating at least one selected region of a body of polymer material,
treating the irradiated region by selective exposure to a monomer at or above a critical temperature at which the monomer diffuses into the irradiated region of the polymer,
selective etching of the thus-treated region of the polymer to result in an accurately formed opening for receiving the end of the optical fiber to be connected, and optionally treating another part of the body of polymer to form a lens surface.

11. A method as claimed in claim 10, in which a lens surface is formed by intumescence resulting from contact with the irradiated region of the polymer by a monomer vapor.
